(19) United States
(12) Patent Application Publication
(10) Pub. No.: US 2004/0205584 A1
(43) Pub. Date: Oct. 14, 2004

(54) System and method for template creation and execution

(75) Inventors: John Robert Pezzanite, Kirkland, WA (US); David A.W. Snelling, Bellevue, WA (US); Shang-Fan Tu, Sammamish, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation

(21) Appl. No.: 10/185,051

(22) Filed: Jun. 28, 2002

(51) Int. Cl. G06F 17/24

(52) U.S. Cl. 715/513

(57) ABSTRACT

A system and method for template creation and execution is disclosed. Template execution is subdivided into steps requiring a higher degree of technical knowledge and steps requiring a higher degree of business/organizational knowledge. During template execution, files from each step in the template creation process are retrieved. A template file is parsed for tags, the tags call a definition file, and the definition file accesses a configuration file. Updated configuration information from the configuration file is inserted into the tags.

### BACKGROUND OF THE INVENTION

1. Field of the Invention

The present invention relates to website layout and population of data. More specifically, the invention relates to the layout, implementation, and configuration of a template.

2. Description of the Prior Art

A template is an electronic file that may be used to store data corresponding to the layout of a website. Creation of a template requires a high degree of both technical knowledge and knowledge of the requirements of the business or organization for which the website is being designed. Technical knowledge includes proficiency in the programming language in which the template is written such as, for example, extensible hypertext markup language (XHTML). Proficiency in XHTML requires an understanding of how structure and definition are added to an XHTML template through the use of headers, tags, elements, and attributes. A header provides a signal that a document is an XHTML document, and the header may contain the version number of the XHTML specification such as, for example, XHTML version 1.0. A tag is custom made by the user, and it consists of brackets signaling the opening and closing of an element. Each XHTML tag represents a specific piece of underlying code, which may be written in a language such as, for example, extensible style language transformation (XSLT), Java™, or C#™. Elements are persons, places, or things representing the actual contents of a document. Attributes are information that describes each element.

In addition to technical knowledge, the creator of a template must also have knowledge of the requirements of the business or organization for which he or she is designing the website. For example, if a website has a link to another web page, the website designer may be required to know the uniform resource locator (URL) of the link. If a website has an ad, the designer may be required to know the desired height, width, border color, and background color of the ad.

The complexity and time required to design a website could be greatly reduced if the creation of a template were divided into steps requiring a higher degree of technical knowledge and steps requiring a higher degree of business and organizational knowledge. Dividing template creation into both technical and business/organizational steps enables those with a higher degree of technical knowledge to work on technical steps and those with a higher degree of business/organizational knowledge to work on business/organizational steps, thereby enabling specialization and increasing the efficiency of template creation.

### SUMMARY OF THE INVENTION

A system and method for template creation and execution is disclosed. A template is first created and then executed. The creation of a template may be subdivided into three steps: layout; implementation; and configuration. Layout and implementation require a higher degree of technical knowledge, while configuration requires a higher degree of business and organizational knowledge. Subdividing tasks that require a higher degree of technical knowledge from tasks that require a higher degree of business and organizational knowledge, enables specialization and, therefore, greater efficiency.

In the layout step, a template is written and stored in a template file. The template file includes custom tags defined by an extended namespace that represents features of a website such as, for example, a link, an ad, and a headline. In the implementation step, tags are defined and stored in a definition file. In the configuration step, configuration information is retrieved and displayed. The configuration information may be updated in response to a request. The updated configuration information is then stored in the configuration file.

After the template has been created, it is executed. At runtime, the template file is parsed for tags. Tag definitions are then called to retrieve updated configuration information from the configuration file. Tag names are replaced with the updated configuration information, and the tag is inserted into a result stream.

### BRIEF DESCRIPTION OF THE DRAWINGS

The present invention will be better understood after reading the following detailed description of the presently preferred embodiments thereof with reference to the appended drawings, in which:

FIG. 1 is a block diagram representing a general-purpose computer system in which aspects of the present invention and/or portions thereof may be incorporated;

FIG. 2 is a high level flowchart of the system and method of the present invention;

FIG. 3 is a flowchart of a template creation method in accordance with an aspect of the present invention;

FIG. 4 is a flowchart of a template configuration method in accordance with an aspect of the present invention;

FIG. 5 is an exemplary display of configuration information in accordance with an aspect of the present invention;

FIG. 6 is another exemplary display of configuration information in accordance with an aspect of the present invention;

FIG. 7 is another exemplary display of configuration information in accordance with an aspect of the present invention; and

FIG. 8 is a flowchart of a template execution method in accordance with an aspect of the present invention.

### DETAILED DESCRIPTION

A system and method for template creation and execution are described below with reference to the aforementioned drawings. Those skilled in the art will readily appreciate that the description given herein with respect to those drawings is for explanatory purposes only and is not intended in any way to limit the scope of the invention to the specific embodiments shown. Throughout the description, like reference numerals are employed to refer to like elements in the respective figures.

Computer Environment

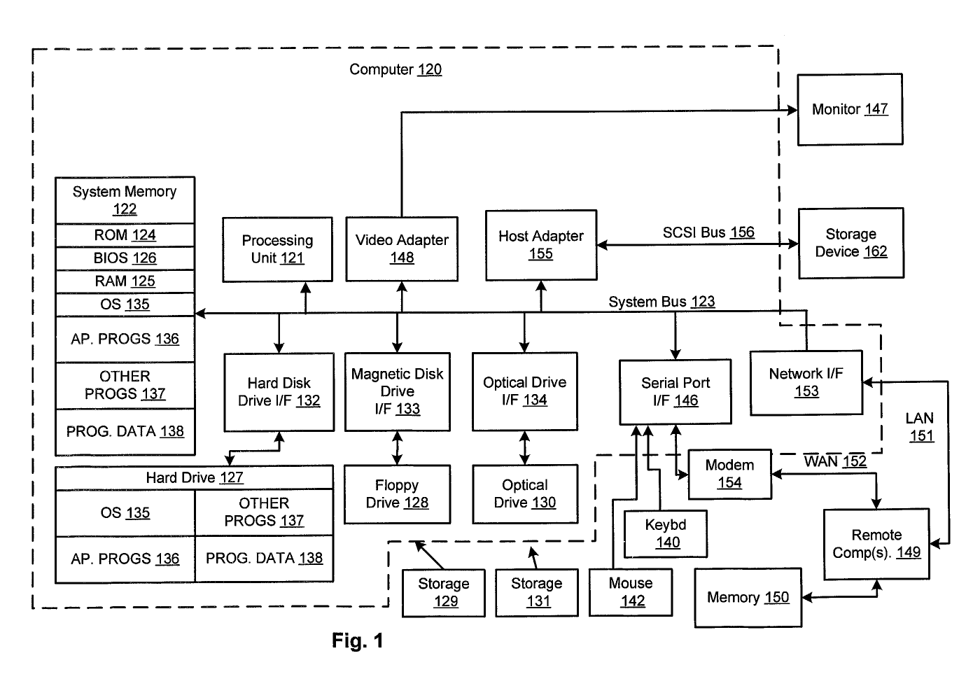

FIG. 1 and the following discussion are intended to provide a brief general description of a suitable computing environment in which the present invention and/or portions thereof may be implemented. Although not required, the invention is described in the general context of computer-executable instructions, such as program modules, being executed by a computer, such as a client workstation or a server. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 120 or the like, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory includes read-only memory (ROM) 124 and random access memory (RAM) 125. A basic input/output system 126 (BIOS), containing the basic routines that help to transfer information between elements within the personal computer 120, such as during start-up, is stored in ROM 124.

The personal computer 120 may further include a hard disk drive 127 for reading from and writing to a hard disk (not shown), a magnetic disk drive 128 for reading from or writing to a removable magnetic disk 129, and an optical disk drive 130 for reading from or writing to a removable optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the personal computer 120.

Although the exemplary environment described herein employs a hard disk, a removable magnetic disk 129, and a removable optical disk 131, it should be appreciated that other types of computer readable media which can store data that is accessible by a computer may also be used in the exemplary operating environment. Such other types of media include a magnetic cassette, a flash memory card, a digital video disk, a Bernoulli cartridge, a random access memory (RAM), a read-only memory (ROM), and the like.

A number of program modules may be stored on the hard disk, magnetic disk 129, optical disk 131, ROM 124 or RAM 125, including an operating system 135, one or more application programs 136, other program modules 137 and program data 138. A user may enter commands and information into the personal computer 120 through input devices such as a keyboard 140 and pointing device 142. Other input devices (not shown) may include a microphone, joystick, game pad, satellite disk, scanner, or the like. These and other input devices are often connected to the processing unit 121 through a serial port interface 146 that is coupled to the system bus, but may be connected by other interfaces, such as a parallel port, game port, or universal serial bus (USB). A monitor 147 or other type of display device is also connected to the system bus 123 via an interface, such as a video adapter 148. In addition to the monitor 147, a personal computer typically includes other peripheral output devices (not shown), such as speakers and printers. The exemplary system of FIG. 1 also includes a host adapter 155, a Small Computer System Interface (SCSI) bus 156, and an external storage device 162 connected to the SCSI bus 156.

The personal computer 120 may operate in a networked environment using logical connections to one or more remote computers, such as a remote computer 149. The remote computer 149 may be another personal computer, a server, a router, a network PC, a peer device or other common network node, and typically includes many or all of the elements described above relative to the personal computer 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise-wide computer networks, intranets, and the Internet.

When used in a LAN networking environment, the personal computer 120 is connected to the LAN 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used.

System and Method of the Present Invention

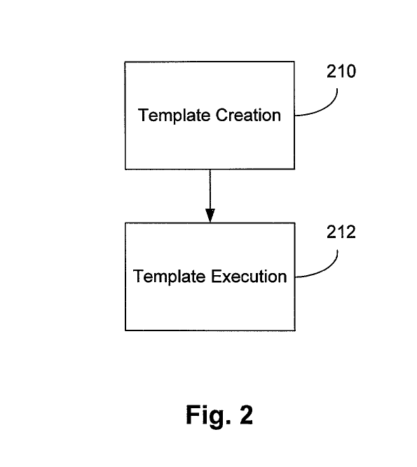

Generally, as shown in FIG. 2, a template is first created at step 210 and then executed at step 212. Template creation step 210 may be subdivided into steps requiring a higher degree of technical knowledge and steps requiring a higher degree of business/organizational knowledge. Subdividing template creation 210 into both technical and business/organizational steps enables website designers with a higher degree of technical knowledge to work on technical steps and website designers with a higher degree of business/organizational knowledge to work on business/organizational steps, thereby enabling specialization and increasing the efficiency of template creation 210.

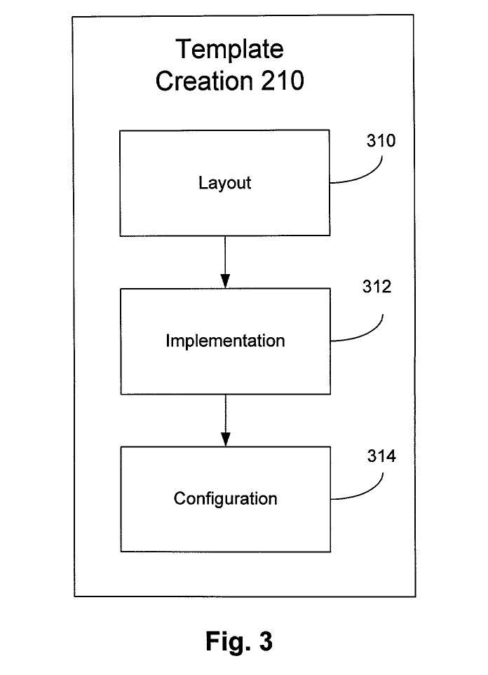

As shown in FIG. 3, template creation step 210 may be subdivided into three steps: layout 310; implementation 312; and configuration 314. Layout 310 and implementation 312 require a higher degree of technical knowledge, while configuration 314 requires a higher degree of business and organizational knowledge. At layout step 310, a template is written and stored in a template file. The template file may be written in a language designated by the world-wide-web consortium (WC3) for website design such as, for example, extensible hypertext markup language (XHTML). The template file includes custom tags defined by an extended namespace that represent features of a website such as, for example, a link, an ad, and a headline.

An exemplary template file is shown below:

<html>
<body>

<p>some standard page content</p>
<sns:results mode=“default”>

</body>
</html>

In the exemplary template file shown above, the tag <sns:results mode=“default”>is a call to a definition, which will be discussed in detail below with reference to implementation step 312.

At implementation step 312, the tags written at layout step 310 are defined and stored in a definition file. The tags may be defined in a language such as, for example, extensible style language transformation (XSLT), Java™, or C#™. The tags are defined to access variable configuration information from a configuration file discussed in detail below with reference to configuration step 314.

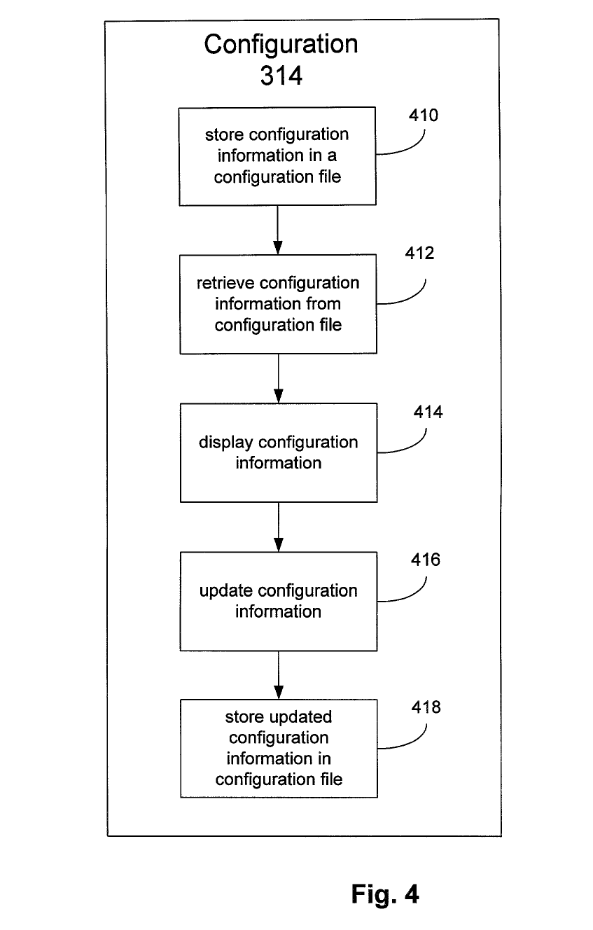

Generally, at configuration step 314, configuration information is stored in a configuration file, retrieved from the configuration file, displayed, and updated. The updated configuration information is then stored in the configuration file. Configuration step 314 is shown in detail in FIG. 4. As shown, at step 410, configuration information is stored in a configuration file. Such configuration information may include at least one of a list of tags, a description of each tag, a list of configuration options for each tag, a description of each configuration option, a current value of each configuration option, and available values for each configuration option.

The list of tags may be a list of all tags used in a particular market. A market may be an international market such as, for example, North America and Southeast Asia or a regional market such as, for example, the Pacific Northwest and New England.

The description of each tag is a brief description of the function of each tag such as, for example, a description that the tag is a link, an ad, or a headline.

Providing a description of each tag reduces the degree of technical knowledge required to configure the tag.

The description of each configuration option may be a brief description of the function of the option such as, for example, a description that the option is a uniform resource locator for a link, a title of a link, a size of an ad, or a localized string. Providing a description of each configuration option reduces the degree of technical knowledge required to configure the tag.

The current value of each configuration option is the value that is currently stored in the configuration file for the option. For example, the current value of the option for the size of an ad may be 1 square inch.

The available values for each configuration option are a group of values from which the current value may be selected. The available values for a configuration option may be dependent on the values of another configuration option. For example, the available values for the size of the border of an ad may be 1.5 inches and 0.25 inches. However, if the current value of the option for the size of an ad is 1 square inch, then the available value for the border of the ad would be only 0.25 inches and not 1.5 inches. 1.5 inches is not an available value because the border of the ad cannot be bigger than the ad itself.

The configuration file may be written in a language such as extensible markup language (XML). An exemplary configuration file is shown below:

<config>
<tag id=“results”uri=“/main/tags/results”>

<mode id=“default”>
<var id=“title”>Australia</var>
<var id=“url”>http://search.ninemsn.com.au/</var>
</mode>

</tag>
</config>

The exemplary configuration file shown above includes the current value of each configuration option. For example, in the exemplary configuration file shown above, the current value of the title of the link is “Australia”, and the current value of the URL of the link is “http://search.ninemsn.com.au”.

After the configuration information has been stored in the configuration file, it is retrieved from the configuration file at step 412. At step 414, the configuration information is displayed. The configuration information may be displayed on the screen of monitor 147 connected to personal computer 120. At step 416, configuration information is updated. Configuration information may be updated by changing the current value of a configuration option in response to a request. At step 418, updated configuration information is stored in the configuration file.

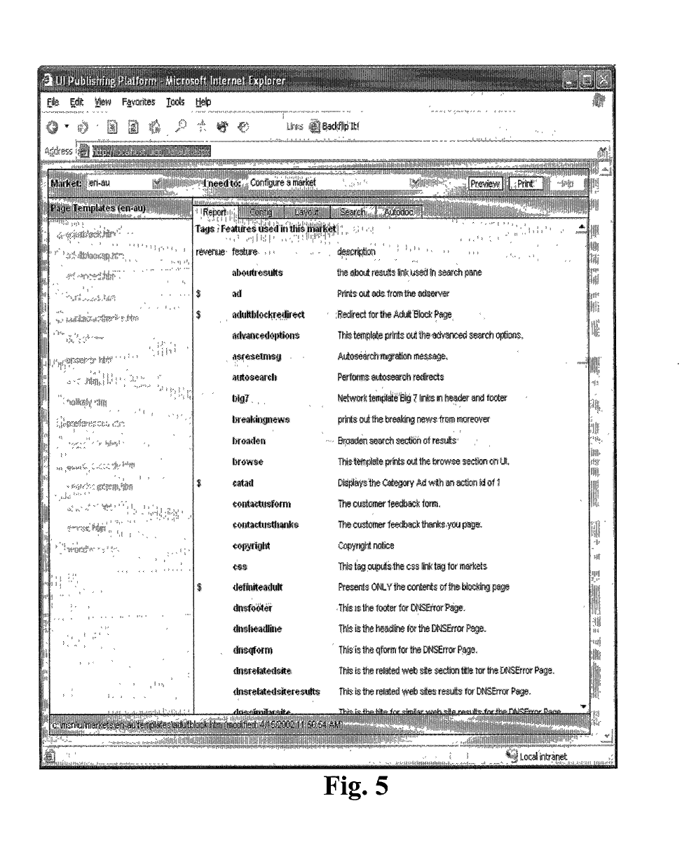

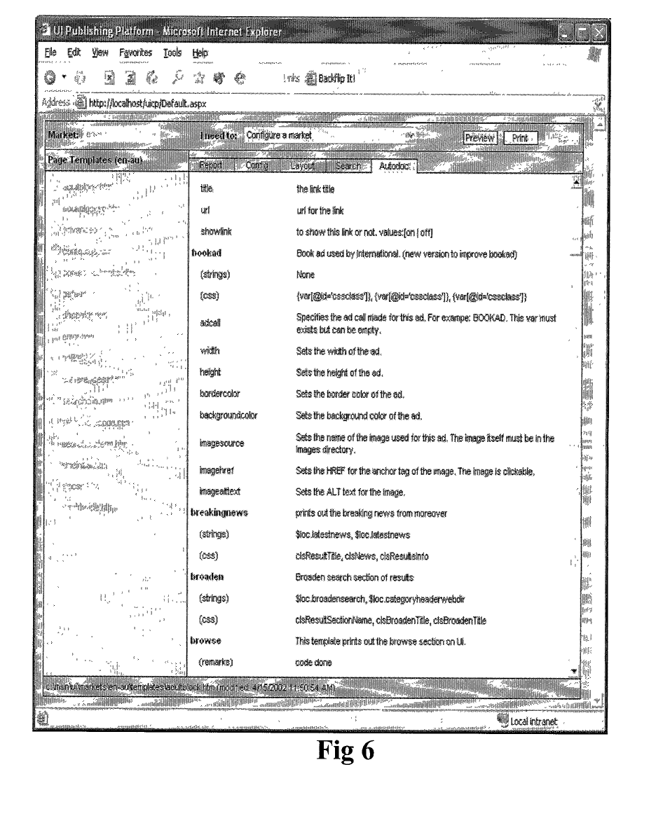

An exemplary display in accordance with step 414 of a list of tags and a description of each tag in a market is shown in FIG. 5. Each tag is listed under the “feature” column, and each tag's description is displayed under the “description” column. Another exemplary display in accordance with step 414 of a list of the configuration options for the tags shown in FIG. 5 is shown in FIG. 6. Each tag is displayed in bold in the left column, and the configuration options for each tag are displayed under each tag in the left column. The description of each tag and each configuration option are displayed in the right column.

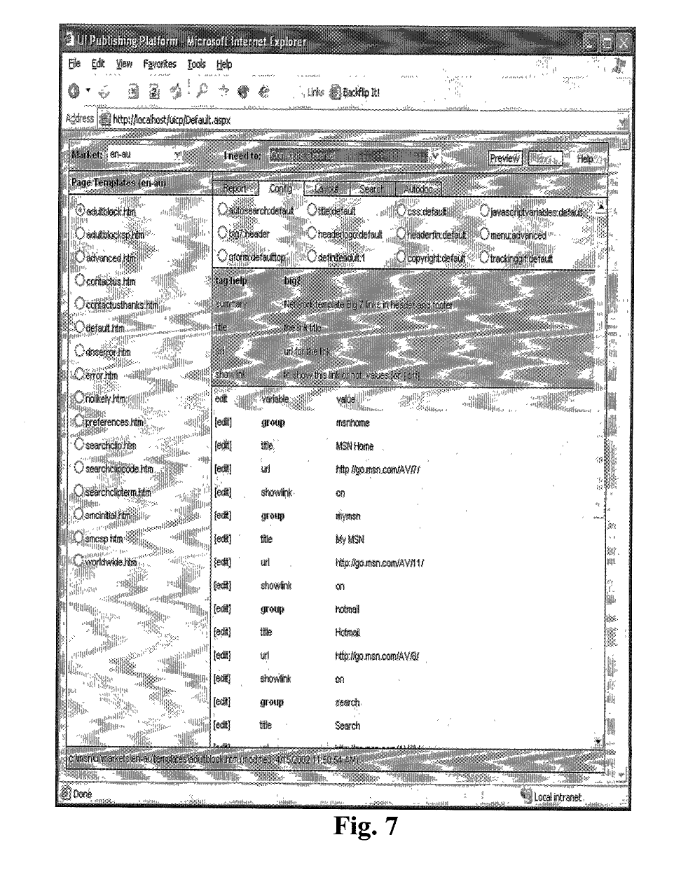

An exemplary display for updating configuration information in accordance with step 416 is shown in FIG. 7. In the dark shaded box, a help box is shown for a particular tag, “big7”. The help box shows a description of the tag on the second line marked “description”. The next three lines of the help screen show the description of each configuration option for the “big7” tag. Under the help box, a box for editing the current value of configuration options is displayed. Each tag is designated by the word “group” in bold letters. The title of each tag is displayed to the right of the word “group”. The configuration options for each tag are displayed on the lines following the word “group”. A description of each configuration option is displayed to the right of each configuration option. To edit a configuration option, a user must click on “[edit]” next to the option that the user wishes to change.

As should be appreciated, a market is not limited to a single configuration file. A market may contain multiple configuration files, each configuration file corresponding to a different set of features. For example, a market may have a separate configuration file having all the localizable strings for the market. Additionally, a market may have a separate configuration file having assorted dynamic information.

Thus, template creation step 210 may be subdivided into three steps: layout 310; implementation 312; and configuration 314. Layout 310 and implementation 312 require a higher degree of technical knowledge, while configuration 314 requires a higher degree of business and organizational knowledge. Subdividing template creation 210 into both technical and business/organizational steps enables website designers with a higher degree of technical knowledge to work on technical steps and website designers with a higher degree of business/organizational knowledge to work on business/organizational steps, thereby enabling specialization and increasing the efficiency of template creation 210.

Subdividing template creation into three steps results in at least three separate files having data corresponding to the template: a template file, a definition file, and at least one configuration file. At runtime, when, for example, a link to an HTML page is clicked, the corresponding template must be executed. During template execution 212, data from the three template creation files must be retrieved and inserted into a result stream.

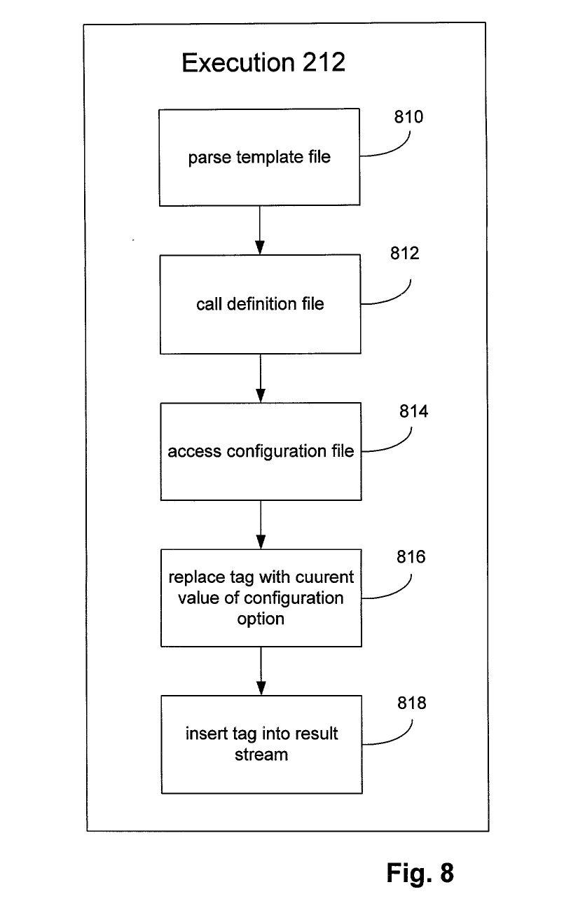

Template execution step 212 is shown in detail in FIG. 8. At step 810, the template file written at layout step 310 is parsed for tags. At step 812, the definition file written at implementation step 312 is called. As discussed previously with reference to FIG. 3, tags in the template may be a call to the definition file. This tag call may contain a code “id” and a mode “id”. An example of such a tag call is the tag: <sns:results mode=“default”>. This is a call to the tag definition code “results” with mode “default”. As should be appreciated, if a tag has no configuration options, then no tag definition is called and the tag is inserted directly into the result stream. An example of such an optionless tag is the tag: <p>some standard page content</p>.

At step 814, the tag definition accesses the configuration file to obtain the current value of each configuration option for the tag. For example, a call to the tag definition code “results” with mode “default” accesses configuration information in the configuration file under tag “results” and mode “default”. At step 816, the tag is replaced with the current value of each configuration option, and, at step 818 the tag is inserted into the result stream. Finally, the resulting HTML page may be displayed.

Thus, a system and method for template creation and execution have been disclosed. Template creation step 210 is subdivided into three steps: layout 310, implementation 312, and configuration 314. Layout 310 and implementation 312 require a higher degree of technical knowledge, while configuration 314 requires a higher degree of business and organizational knowledge. Subdividing template creation 210 into both technical and business/organizational steps specialization and, thereby increases the efficiency of template creation 210. At template execution step 212, files from each step in the template creation process are retrieved. The template file is parsed for tags, the tags call the definition file, and the definition file accesses configuration information from the configuration file. Updated configuration information is inserted into the tags.

The programming necessary to effectuate the processes performed in connection with the present invention is relatively straight-forward and should be apparent to the relevant programming public. Accordingly, such programming is not attached hereto. Any particular programming, then, may be employed to effectuate the present invention without departing from the spirit and scope thereof.

While the invention has been described and illustrated with reference to specific embodiments, those skilled in the art will recognize that modification and variations may be made without departing from the principles of the invention as described above and set forth in the following claims. Accordingly, reference should be made to the appended claims as indicating the scope of the invention.

We claim:

1. A template configuration method, comprising the steps of:
retrieving configuration information;
displaying configuration information; and
storing configuration information.

2. The method of claim 1, wherein the step of retrieving configuration information comprises retrieving at least one of a list of tags, a description of each tag, a list of configuration options for each tag, a description of each configuration option, a current value of each configuration option, and available values for each configuration option.

3. The method of claim 2, comprising retrieving a list of all tags used in a market.

4. The method of claim 2, comprising retrieving a description that a tag is one of a link, an ad, and a headline.

5. The method of claim 2, comprising retrieving a description that a configuration option is one of a uniform resource locator for a link, a title of a link, a size of an ad, and a localized string.

6. The method of claim 2, comprising retrieving available values for each configuration option, the available values of one of the configuration options being dependent on the current value of another configuration option.

7. The method of claim 2, further comprising changing the current value of a configuration option in response to a request.

8. A template execution method, comprising the steps of:
parsing a template for a tag;
calling a tag definition to retrieve a current value of a configuration option of the tag;
replacing the tag name with the current value of the configuration option; and
inserting the tag into a result stream.

9. The method of claim 8, further comprising the step of if the tag has no configuration option, then inserting the tag directly into the result stream.

10. The method of claim 8, comprising parsing a template for a tag, the tag representing one of a link, an ad, and a headline.

11. The method of claim 8, comprising calling a tag definition written in one of extensible style language transformation, Java, and C #.

12. The method of claim 8, comprising calling a tag definition to retrieve a current value of a configuration option from a configuration file, the configuration file having the current value of all configuration options used in a market.

13. The method of claim 8, comprising calling a tag definition to retrieve a current value of a configuration option, the current value selected from a group of available values.

14. The method of claim 13, comprising calling a tag definition to retrieve a current value of a configuration option, the current value selected from a group of available values dependent on the current value of another configuration option.

15. The method of claim 8, comprising calling a tag definition to retrieve a current value of a configuration option, the configuration option being one of a uniform resource locator for a link, the title of a link, the size of an ad, and a localized string.

16. A system for creation and management of templates for use in a dynamic information system, comprising:
a layout module that includes templates having tags;
an implementation module that implements the tags; and
a configuration module that configures the layout of the dynamic information system in accordance with said templates.

17. A system as recited in claim 16, wherein said tags represent specific software code executed at runtime.

18. A system as recited in claim 17, wherein the tags are implemented in one of extensible style language transformation, Java, and C #.

19. A system as recited in claim 16, wherein said configuration module includes business rules for at least one particular market.

20. A system as recited in claim 16, wherein said templates define a layout of said dynamic information system presentation interface.
